(19) United States
(12) Patent Application Publication
(10) Pub. No.: US 2015/0154812 A1
(43) Pub. Date: Jun. 4, 2015

(54) TRANSPORTATION CARD SWIPING MANAGEMENT DEVICE, SYSTEM, AND METHOD THEREOF

(71) Applicants: Fu Tai Hua Industry (Shenzhen) Co., Ltd., Shenzhen (CN); HON HAI PRECISION INDUSTRY CO. LTD., New Taipei (TW)

(72) Inventor: XIAN QIAN, Shenzhen (CN)

(21) Appl. No.: 14/524,178

(22) Filed: Oct. 27, 2014

(30) Foreign Application Priority Data
Nov. 30, 2013 (CN) 201310621963.9

(51) Int. Cl. G07B 15/04

(52) U.S. Cl. CPC G07B 15/04

(57) ABSTRACT

A transportation card swiping management method includes: obtaining information of a transportation card read by a card reader; obtaining a geographical location of a vehicle located by a GPS unit; determining current station where the vehicle locates according to a station relationship table and the geographical location of the vehicle; and associating the identity of the transportation card and the obtained station and storing the associated identity and the station to the storage device, and calculating a fare according to two stations associated with the identity of the transportation card and deducting the fare from the transportation card when there are two stations associated with the identity of the transportation card stored in the storage device.

### CROSS-REFERENCE TO RELATED APPLICATIONS

This application claims priority to Chinese Patent Application No. 201310621963.9 filed on Nov. 30, 2013, the contents of which are incorporated by reference herein.

### FIELD

The present disclosure relates to management devices, and particularly to a transportation card swiping management device, system, and method thereof.

### BACKGROUND

Commonly, the use of public transportation involves people paying fares by swiping transportation cards.

### BRIEF DESCRIPTION OF THE DRAWINGS

Implementations of the present technology will now be described, by way of example only, with reference to the attached figures.

FIG. 1 is a block diagram of an embodiment of a transportation card swiping management device.

FIG. 2 is a block diagram of an embodiment of a transportation card swiping management system.

FIG. 3 is a flowchart diagram of an embodiment of a transportation card swiping management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected. The term “coupled” is defined as connected, whether directly or indirectly through intervening components, and is not necessarily limited to physical connections.

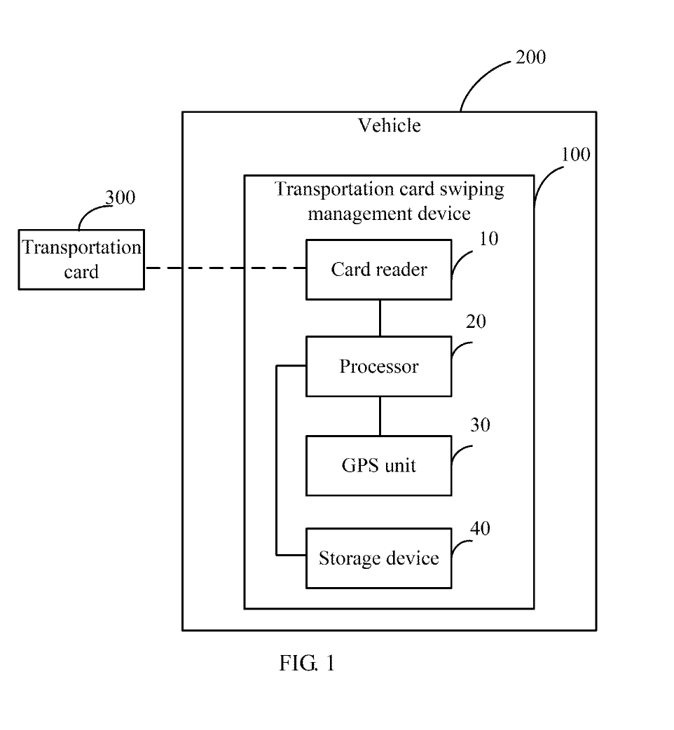

Referring to FIG. 1, a transportation card swiping management device 100 is illustrated. The transportation card swiping management device 100 includes a card reader 10, a processor 20, a global position system (GPS) unit 30, and a storage device 40. The transportation card swiping management device 100 is installed in a vehicle 200, and is used to manage the charge of card swiping. The card reader 10 is used to read information from a transportation card 300 when the transportation card 300 is near the card reader 10. The vehicle 200 can be a bus, a subway, and the like. In at least one embodiment, the transportation card 300 can be a radio frequency (RF) card and the card reader 10 can be a RF card reader. In another embodiment, the transportation card 300 can be a near field communication (NFC) card and the card reader 10 can be a NFC card reader. The processor 20 is coupled to the card reader 10, the global position system (GPS) unit 30, and the storage device 40.

The GPS unit 30 is used to locate a geographical location of the vehicle 200 with the transportation card swiping management device 100 installed. The GPS unit 30 can be a GPS navigation device.

The storage device 40 stores a station relationship table which defines relationships between a number of geographical locations and a number of stations.

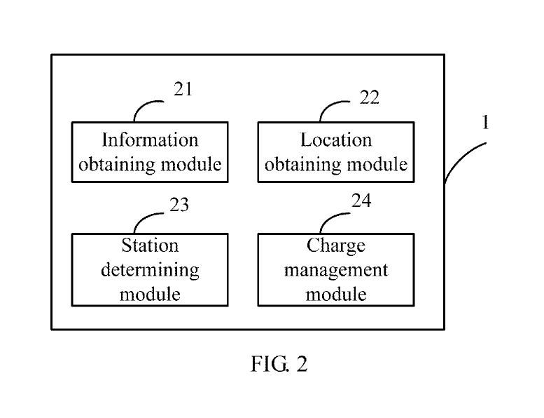

Referring to FIG. 2, a transportation card swiping management system 1 is stored in the storage device 40 and executed by the processor 20. The transportation card swiping management system 1 includes an information obtaining module 21, a location obtaining module 22, a station determining module 23, and a charge management module 24. The modules of the transportation card swiping management system 1 can be a collection of software instructions stored in the storage device 40 and executed by the processor 20, or can include functionality represented as hardware or integrated circuits, or as software and hardware combinations, such as a special-purpose processor or a general-purpose processor with special-purpose firmware.

In at least one embodiment, the processor 20 can be a central processing unit, a digital signal processor, or a single chip, for example. In at least one embodiment, the storage device 40 can be an internal storage system, such as a flash memory, a random access memory (RAM) for temporary storage of information, and/or a read-only memory (ROM) for permanent storage of information. The storage device 40 can also be a storage system, such as a hard disk, a storage card, or a data storage medium. The storage device 40 can include volatile and/or non-volatile storage devices. In at least one embodiment, the storage device 40 can include two or more storage devices such that one storage device is a memory and the other storage device is a hard drive. Additionally, one or more of the storage devices 40 can be located either entirely or partially external relative to the transportation card swiping management device 100.

The information obtaining module 21 is used to detect and obtain the information of the transportation card 300 read by the card reader 10. The information of the transportation card 300 includes identity of the transportation card 300 and a balance of the transportation card 300. The identity of the transportation card 300 can be a card number, a serial number, and is used to identify the transportation card 300.

The location obtaining module 22 is used to obtain the geographical location of the vehicle 200 currently located by the GPS unit 30 when the information obtaining module 21 obtains the information of the transportation card 300 read by the card reader 10.

The station determining module 23 is used to obtain the station relationship table from the storage device 40, and determine current station where the vehicle 200 locates according to the station relationship table and the geographical location of the vehicle 200. That is, the station determining module 23 determines the current station corresponding to the geographical location of the vehicle 200 according to relationships between the number of geographical locations and the number of stations defined in the station relationship table.

The charge management module 24 is used to associate the identity of the transportation card 300 with the obtained station and store the associated identity and the station to the storage device 40. When there are two stations associated with the same identity of the transportation card 300 stored in the storage device 40, the charge management module 24 further calculates a fare according to the two stations associated with the identity of the transportation card 300, and deducts the fare from the transportation card 300.

In detail, when the passenger gets on the vehicle 200, the passenger can swipe his/her transportation card 300 by closing the transportation card 300 to the card reader 10, the information obtaining module 21 can obtain the information of the transportation card 300 read by the card reader 10 at the first time, and then the station determining module 23 determines a first station, and the charge management module 24 associates the identity of the transportation card 300 and the obtained first station, and then stores them to the storage device 400. When the passenger gets off the vehicle 200, the passenger can swipe his/her transportation card 300 again by closing the transportation card 300 to the card reader 10, the information obtaining module 21 can obtain the information of the transportation card 300 read by the card reader 10 at the second time, and then the station determining module 23 determines a second station, the charge management module 24 associates the identity of the transportation card 300 and the obtained second station, and then stores them to the storage device 400. Therefore, after the passenger swipes the transportation at the second time, the storage device 400 would store two stations associated to the identity of the vehicle 200. The charge management module 24 can deduct the fare from the transportation card 300 when the passenger swipes the transportation at this time, namely the second time.

In the embodiment, the storage device 40 further stores a fare relationship table which defines different fares corresponding to different station sections from one station to another station. In at least one embodiment, each station section is a section from one station to another station. The charge management module 24 determines the station section according to the two stations associated with the identity of the transportation card 300, and then determines the fare corresponding to the station section according to the fare relationship table.

In at least one embodiment, the station relationship table and the fare relationship table can be generated by experience, and can be pre-stored in the storage device 40.

In at least one embodiment, the charge management module 24 further deletes the associated station and identity of the transportation card 300 stored in the storage device 40 after the charge management module 24 deducts the fare from the transportation card 300.

In at least one embodiment, an amount of the card reader 10 is two, and the two card readers 10 are respectively set on a front door and a rear door of the vehicle 200. The passenger can swipe his/her transportation card 300 via the card reader 10 set on the front door when the passenger gets on the vehicle 200 via the front door, and can swipe his/her transportation card 300 via the card reader 10 set on the rear door when the passenger gets off the vehicle 200 via the rear door of the vehicle 200.

In at least one embodiment, the processor 20, the GPS unit 30, and the storage device 40 are integrated in a single device. The two card readers 10 are independent from the processor 20, the GPS unit 30, and the storage device 40, and communicates with the processor 20, the GPS unit 30, and the storage device 40 via a wired mode or a wireless mode. In another embodiment, the mount of the card reader 10 is one, and the card reader 10, the processor 20, the GPS unit 30, and the storage device 40 are all integrated in the single device.

Therefore, in the present disclosure, the fare can be calculated and deducted from the transportation card 300 automatically by swiping the transportation card 300 when the passenger gets on the vehicle 200 and gets off the vehicle 200.

In other embodiments, when the passenger swipes his/her transportation card 300 at the first time, namely when the passenger gets on the vehicle 200, the charge management module 24 stores the associated station and identity of the transportation card 300 to the storage device 40, and deducts a total fare from the current station to the terminal station. When the passenger gets off the vehicle 200 and swipes the transportation card 300 again, the charge management module 24 determines the current station, and determine a factual fare corresponding to a station section from the station where the passenger gets on the vehicle 200 to the station where the passenger gets off the vehicle 200, and refunds a redundant fare to the transportation card 300 according to a difference between the total fare and the factual fare.

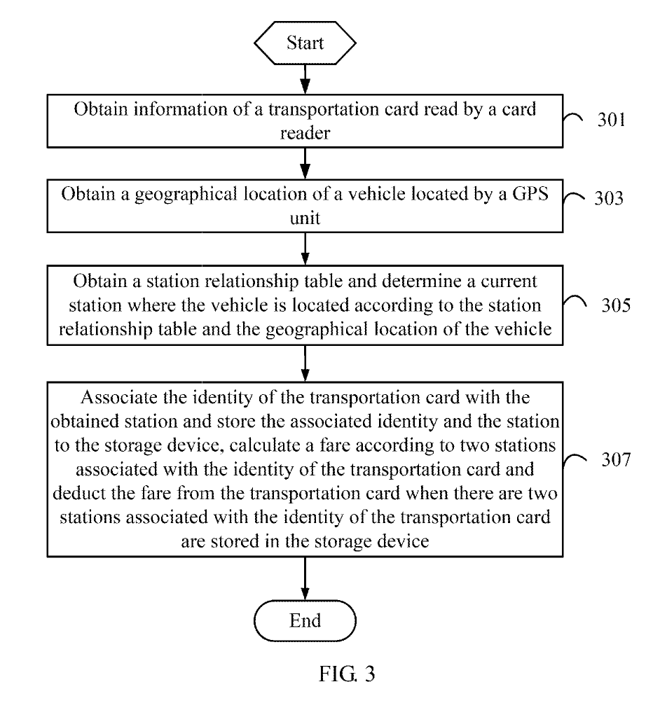

FIG. 3 illustrates a flowchart of a transportation card swiping management method. The method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized without departing from this disclosure. The example method can begin at block 301.

In block 301, an information obtaining module detects and obtains information of a transportation card read by a card reader, the information of the transportation card includes at least an identity of the transportation card.

In block 303, a location obtaining module obtains a geographical location of a vehicle including the card reader located by a GPS unit when the information obtaining module obtains the information of the transportation card read by the card reader.

In block 305, a station determining module obtains a station relationship table defining relationships between a number of geographical locations and a number of stations from a storage device, and determines current station according to the station relationship table and the obtained geographical location of the vehicle.

In block 307, a charge management module associates the identity of the transportation card with the obtained station and store the associated identity and the station to the storage device, and calculates a fare according to two stations associated with the identity of the transportation card and deducts the fare from the transportation card when there are two stations associated with the identity of the transportation card stored in the storage device. In detail, the storage device further stores a fare relationship table which defines different fares corresponding to different station sections from one station to another station, the charge management module determines the station section according to the two stations associated with the identity of the transportation card, and then determines the fare corresponding to the station section according to the fare relationship table, and deducts the fare from the transportation card.

In the embodiment, the transportation card swiping management method can further include: the charge management module deletes the associated station and identity of the transportation card stored in the storage device after the charge management module deducts the fare from the transportation card.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transportation card swiping management device comprising:
a card reader configured to read information of a transportation card when the transportation card is near the card reader, wherein the information of the transportation card comprises at least an identity of the transportation card;
a global position system (GPS) unit configured to locate a geographical location of a vehicle with the transportation card swiping management device installed;
a storage device configured to store a station relationship table which defines relationships between a plurality of geographical locations and a plurality of stations;
at least one processor configured to execute a plurality of modules, the plurality of modules comprising:
an information obtaining module configured to detect and obtain the information of the transportation card read by the card reader;
a location obtaining module configured to obtain the geographical location of the vehicle located by the GPS unit when the information obtaining module obtains the information of the transportation card read by the card reader;
a station determining module configured to obtain the station relationship table from the storage device, and determine a current station where the vehicle is located according to the station relationship table and the geographical location of the vehicle; and
a charge management module configured to associate the identity of the transportation card with the current station and store the associated identity and the current station to the storage device, and further configured to calculate a fare according to two stations associated with the identity of the transportation card and deducts the fare from the transportation card when there are two stations associated with the identity of the transportation card stored in the storage device.

2. The device according to claim 1, wherein the storage device further stores a fare relationship table which defines different fares corresponding to different station sections from one station to another station, the charge management module determines a station section according to the two stations associated with the identity of the transportation card, and then determines the fare corresponding to the station section according to the fare relationship table, and then deducts the fare from the transportation card.

3. The device according to claim 1, wherein the charge management module is further configured to delete the associated station and identity of the transportation card stored in the storage device after the charge management module deducts the fare from the transportation card.

4. The device according to claim 1, wherein the station determining module determine the current station corresponding to the geographical location of the vehicle according to the relationships between a plurality of geographical locations and a plurality of stations defined in the station relationship table.

5. The device according to claim 1, wherein the card reader is a radio frequency (RF) card reader or a near field communication (NFC) card reader.

6. The device according to claim 1, wherein an amount of the card reader is two, and the two card readers are respectively set on a front door and a rear door of the vehicle.

7. The device according to claim 1, wherein an amount of the card reader is one.

8. A transportation card swiping management system, running in a transportation card swiping management device of a vehicle, the system comprising:
one or more processors;
a plurality of modules which are collections of instructions executed by the one or more processors, the plurality of modules comprising:
an information obtaining module configured to detect and obtain information of a transportation card read by a card reader of the transportation card swiping management device;
a location obtaining module configured to obtain a geographical location of the vehicle located by a GPS unit of the transportation card swiping management device when the information obtaining module obtains the information of the transportation card read by the card reader;
a station determining module configured to obtain a station relationship table defining relationships between a plurality of geographical locations and a plurality of stations from a storage device of the transportation card swiping management device, and determine a current station where the vehicle is located according to the station relationship table and the geographical location of the vehicle; and
a charge management module configured to associate the identity of the transportation card with the current station and store the associated identity and the current station to the storage device, and further configured to calculate a fare according to two stations associated with the identity of the transportation card and deducts the fare from the transportation card when there are two stations associated with the identity of the transportation card stored in the storage device.

9. The system according to claim 8, wherein the charge management module determines a station section according to the two stations associated with the identity of the transportation card, and then determines the fare corresponding to the station section according to a fare relationship table defining different fares corresponding to different station sections.

10. The system according to claim 8, wherein the charge management module is further configured to delete the associated station and identity of the transportation card stored in the storage device after the charge management module deducts the fare from the transportation card.

11. The system according to claim 8, wherein the station determining module determine the current station corresponding to the geographical location of the vehicle according to the relationships between a plurality of geographical locations and a plurality of stations defined in the station relationship table.

12. A transportation card swiping management method comprising:
obtaining information of a transportation card read by a card reader;
obtaining a geographical location of a vehicle located by a GPS unit when obtaining the information of the transportation card read by the card reader;
obtaining a station relationship table defining relationships between a plurality of geographical locations and a plurality of stations from a storage device of the transportation card swiping management device, and determining a current station where the vehicle is located according to the station relationship table and the geographical location of the vehicle; and
associating the identity of the transportation card with the current station and storing the associated identity and the current station to the storage device, calculating a fare according to two stations associated with the identity of the transportation card and deducting the fare from the transportation card when there are two stations associated with the identity of the transportation card stored in the storage device.

13. The method according to claim 12, wherein the step of calculating a fare according to two stations associated with the identity of the transportation card comprising:
determining a station section according to the two stations associated with the identity of the transportation card; and
determining the fare corresponding to the station section according to the fare relationship table defining different fares corresponding to different station sections from one station to another station.

14. The method according to claim 12, further comprising:
deleting the associated station and identity of the transportation card stored in the storage device after deducting the fare from the transportation card.

15. The method according to claim 12, wherein the step of determining a current station where the vehicle is located according to the station relationship table and the geographical location of the vehicle comprising:
determining the current station corresponding to the geographical location of the vehicle according to the relationships between a plurality of geographical locations and a plurality of stations defined in the station relationship table.
